(19) United States
(12) Patent Application Publication
(10) Pub. No.: US 2010/0133975 A1
(43) Pub. Date: Jun. 3, 2010

(54) Linear Lens Envelope for Photographic Lighting

(76) Inventor: Sergio Alejandro Ortiz-Gavin, Los Angeles, CA (US)

Correspondence Address: EDWARD C. SCHEWE, 1600 Rosecrans Avenue, Fourth Floor, MANHATTAN BEACH, CA, 90266, US

(21) Appl. No.: 12/629,838

(22) Filed: Dec. 2, 2009

Related U.S. Application Data
(60) Provisional application No. 61/119,093, filed on Dec. 2, 2008.

(51) Int. Cl. H01J 5/16; H01J 9/24

(52) U.S. Cl. 313/110; 445/23

(57) ABSTRACT

An envelope for photographic lighting that enhances and modifies light from a light source to create desirable light for photography. The envelope is constructed to include a series of linear lenses surrounding a light source to produce multiple distorted images of light at a diameter corresponding to the curvature of the lens and the distance from the light source. The envelope homogenizes the distribution of light by multiplying the projected light dispersion pattern to modify or “shape” the light for stage, studio, motion picture or still photography.

### RELATED APPLICATION DATA

This application claims the benefit of U.S. Provisional Patent Application Ser. No. 61/119,093 filed on Dec. 2, 2008.

### BACKGROUND OF THE INVENTION

1. Field of the Invention

The invention relates to an envelope for photographic lighting such as flash tubes and particularly, an envelope for photographic light sources that utilizes chromatic aberration and a prism effect to generate a complex, efficient and desirable quality of light for stage, studio, motion picture and still photography.

2. Description of the Related Art

Many different lighting techniques have been used for stage, studio, motion picture and still photography for many years. However, conventional lighting systems do not fully utilize chromatic aberration and a prism effect in an effective manner to enhance and shape the light for photography. A need exists for improved and novel apparatus, systems and methods that overcome the limitations in conventional lighting systems.

### SUMMARY OF THE INVENTION

An envelope for photographic lighting that enhances and modifies light from a light source to create desirable light for photographic purposes including stage, studio, motion picture and still photography.

The novel envelope of the present invention is constructed to include a series of linear lenses. The individual linear lenses of the envelope come together to form a modified triangular prism. The prisms result from the angles created when the edges of the lenses come together. The linear lenses are approximately semi-circular in configuration but other configurations are within the scope of the present invention.

The invention produces multiple distorted images of the light source at a diameter corresponding to the curvature of the lens and the distance from the light source. The novel envelope of the present invention in effect increases the effective diameter of the light source. The envelope thereby homogenizes the distribution of light by multiplying the projected light dispersion pattern to modify or “shape” the light.

In embodiments of the invention, the envelope is made from a borosilicate glass and in further embodiments the envelope is made of Pyrex® glass. The invention includes materials for constructing the envelope known to skilled persons for transmitting light and is not limited to an envelope of glass. The linear lenses and prisms vary in size, shape, quantity and length depending on the diameter and length of the envelope and the lenses and prisms can be constructed to create a desired effect or effects, all of which are included in the present invention.

In embodiments of the invention, the light source is a xenon gas capacitor discharge flash tube used with a parabolic reflector. An approximate 500 Volt+DC current from a capacitor bank is applied to the flash tube cathode and a 500 Volt−DC current from a capacitor bank is applied to the flash tube anode. A high voltage pulse ignites the xenon gas in the light source resulting in an intense short duration full spectrum white light at approximately 6500 degrees Kelvin.

The prisms of the envelope cause the white light generated from the xenon flash tube light source ignition to divide into its constituent spectral colors and recombine in the complex geometry of the parabolic reflector. This results in a more complex, highly efficient and very desirable quality of light that can be used, for example, for flash photography.

Further advantages and embodiments of the invention will be apparent to persons skilled in the art from the drawings and description set forth herein.

### BRIEF DESCRIPTION OF THE DRAWINGS

FIG. 1 is a perspective view illustrating one embodiment of the invention used with a parabolic reflector.

FIG. 2 is an elevation view of one embodiment of the invention showing the envelope and a light source to be secured within the envelope.

FIG. 3 is a plan view of a simplified optical system.

FIG. 4 is an illustrative section view taken along line 4-4 of FIG. 2 illustrating one embodiment of the invention with the light source placed within the envelope.

FIG. 5 is a plan view of one embodiment of the invention illustrating a prism effect.

FIG. 6 is a section view taken along line 6-6 of FIG. 5 illustrating an approximate optical effect of embodiments of the present invention showing multiple diminished and distorted images of the light source outside of the envelope.

FIG. 7 is a plan view of a simplified optical system.

FIG. 8 is a plan view of one embodiment of the invention illustrating an approximate prism effect.

FIG. 9 is a plan view of a simplified optical system.

FIG. 10 is a plan view of one embodiment of the invention illustrating an approximate light interference pattern and an approximate prism effect.

FIG. 11 is an elevation view of one embodiment of the invention showing a bi-tube light source to be placed within the envelope.

FIG. 12 is an illustrative section view taken along line 12-12 of FIG. 11 illustrating one embodiment of the invention with the bi-tube light source placed within the envelope.

FIG. 13 is a plan view of one embodiment of the invention illustrating an approximate prism effect.

FIG. 14 is a plan view of one embodiment of the invention illustrating an approximate light interference pattern.

### DETAILED DESCRIPTION OF EMBODIMENTS OF THE INVENTION

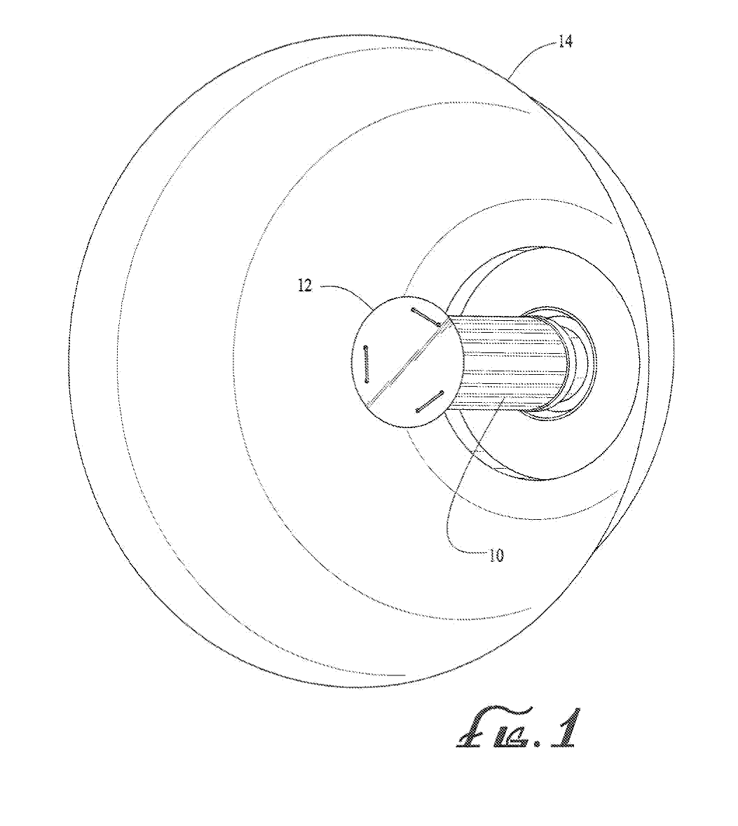

FIG. 1 illustrates an embodiment of the invention with the envelope 10 having a counterlight reflector 12 attached at one end of the envelope 10. The combination of the envelope 10 and counterlight reflector 12 are placed within a parabolic reflector 14 for use in photography and to create additional desired light effects. The term envelope 10 includes many configurations that are used to shield a light source including tubular, non-tubular and designs and shapes known to skilled persons all of which are within the scope of the invention.

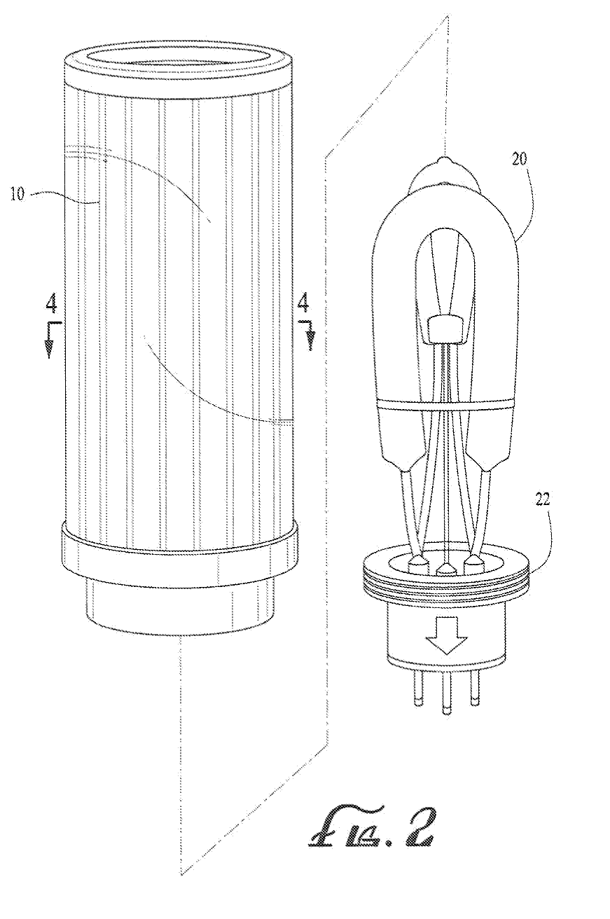

FIG. 2 illustrates an embodiment having a light source 20 that is to be secured within the envelope 10. In these embodiments, the light source 20 is a xenon gas capacitor discharge flash tube but the present invention includes and encompasses other photographic light sources known to persons skilled in the art.

In further embodiments, the light source 20 is configured to include threaded connectors 22. In these embodiments, the threaded connectors 22 are configured to couple to compatible threading (not shown) on the base of the envelope 10. The light source 20 is coupled to the envelope 10 in these embodiments by rotating or threading the light source 20 by hand into the envelope 10 in a manner known to skilled persons.

FIG. 3 is a diagram of a simplified optical system that schematically illustrates principles used with embodiments of the invention. A series of prisms 30 is arranged about a light source 20 as shown in FIG. 3. A ray of light 32 from the light source 20 is reflected by a prism 30 to effectively produce an image of the light source 20 within the arrangement of prisms 30 as shown schematically in FIG. 3. The portion of the ray of light 32 that passes through a prism 30 is refracted by the prism 30 to produce a refracted ray of light 34 outside of the arrangement of prisms 30.

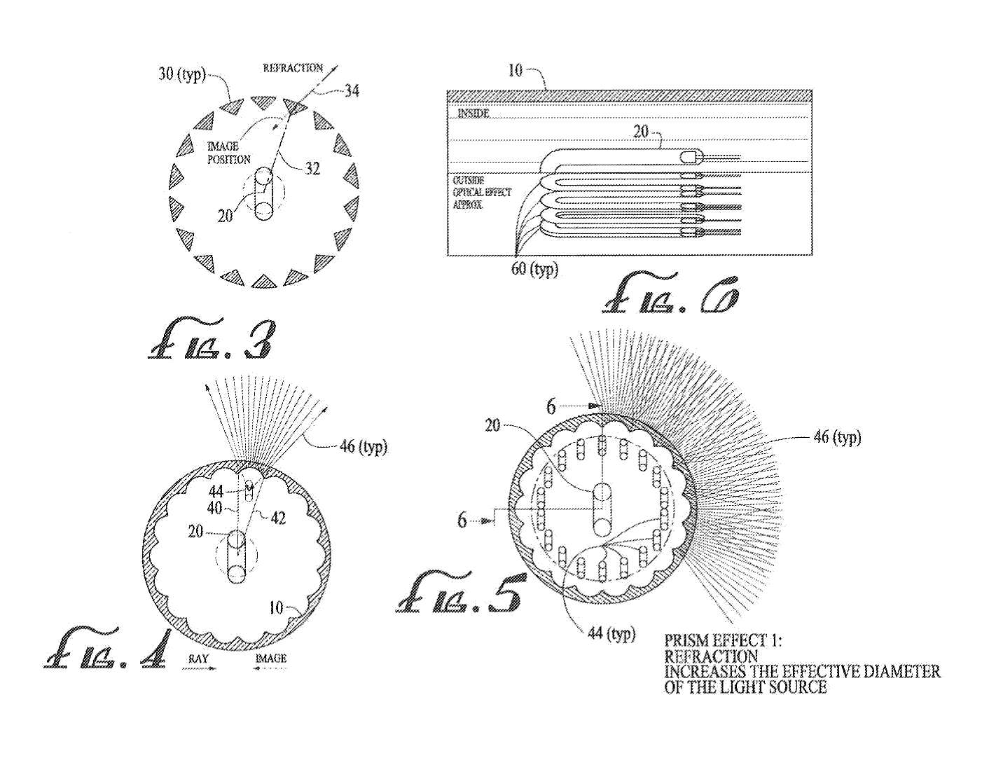

FIG. 4 illustrates the light source 20 that produces the ray of light 40 and the ray of light 42 within the envelope 10. The ray 40 and ray 42 are reflected by the envelope 10 to effectively produce an image 44 of the light source 20 within the envelope 10. Portions of the rays of light 40 and 42 are refracted by the envelope 10 as illustrated in FIG. 4 to produce refracted light rays 46 outside of the envelope 10.

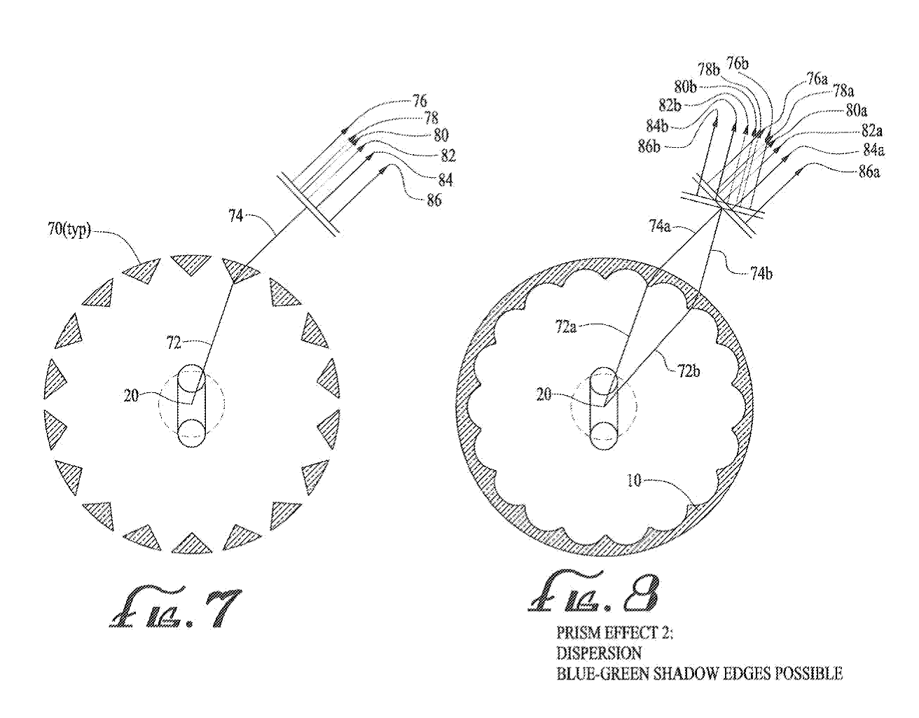

FIG. 5 shows an expanded view of the embodiment of the invention in FIG. 4 illustrating multiple images 44 and multiple refracted light rays 46. FIG. 6 illustrates embodiments of the invention showing in a simplified manner the multiple diminished and distorted images 60 of the light source 20 produced outside of the envelope 10. As can be appreciated from the Figures and the description herein, the configuration of the envelope 10 can be viewed as increasing the effective diameter of the light source 20.

FIG. 7 is a diagram of a simplified optical system that illustrates additional principles of embodiments of the invention. A series of prisms 70 are arranged about a light source 20 that produces a white light. The portion of the ray of light 72 that passes through a prism 70 is refracted by the prism 70 to produce a refracted ray of light 74 outside of the arrangement of prisms 70.

The refracted ray of light 74 in FIG. 7 is dispersed into constituent colors of the color spectrum, including red light 76 and 78, yellow light 80, green light 82, and blue light 84 and 86. As one example, the dispersion can occur at a radius of 2000 mm from the center of the light source 20.

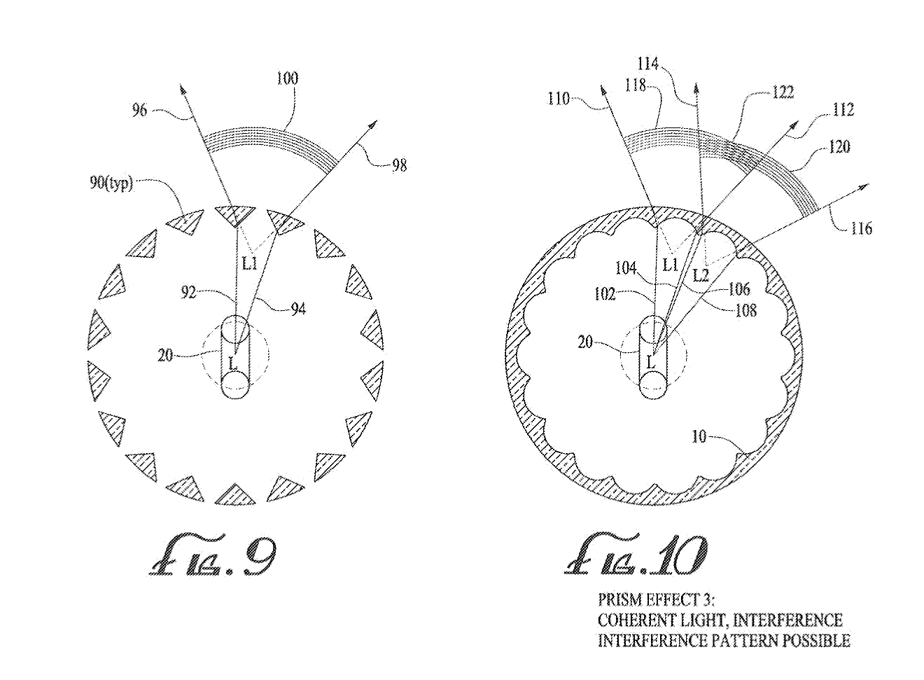

FIG. 8 illustrates further embodiments of the invention. Portions of the rays of light 72a and 72b from the light source 20 are refracted by the envelope 10 to produce refracted light rays 74a and 74b with the light dispersion as approximately illustrated in FIG. 8.

As further illustrated in FIG. 8, the first refracted ray of light 74a is dispersed into constituent colors of the color spectrum, including red light 76a and 78a, yellow light 80a, green light 82a, and blue light 84a and 86a. The second refracted ray of light 74b is dispersed into constituent colors as shown in FIG. 8, including red light 76b and 78b, yellow light 80b, green light 82b, and blue light 84b and 86b. In embodiments of the invention, the dispersion is visible at shadow edges at a color shift to blue as can be understood from the Figures. Dispersion is normally not visible in conventional lighting systems because the colors recombine to white.

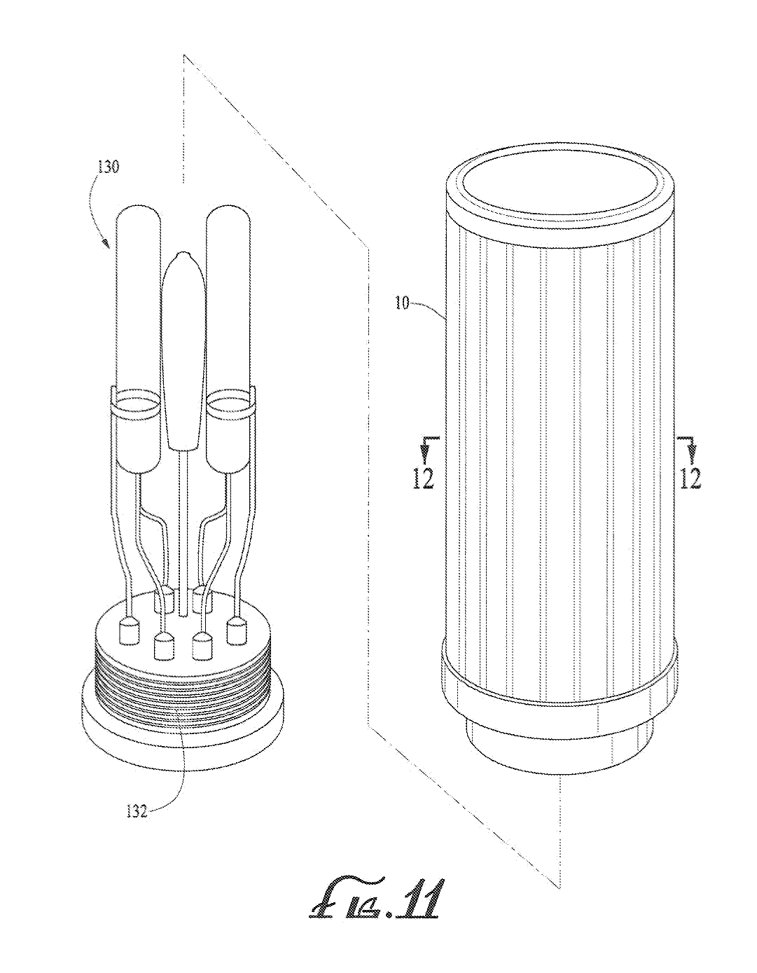

FIG. 9 is a diagram of a simplified optical system that illustrates principles of embodiments of the invention. A series of prisms 90 is arranged about a light source 20 that produces a white light. A ray of light 92 and ray of light 94 from the light source 20 is reflected by a prism 90 to effectively produce an image of the light source 20 within the arrangement of prisms 90 as shown schematically in FIG. 9 as L1. The portion of the ray of light 92 and portion of the ray of light 94 that pass through prisms 90 are refracted by the prisms 90 to produce refracted ray of light 96 and refracted ray of light 98 that produce wave fronts 100.

FIG. 10 illustrates the principles of FIG. 9 as applied to embodiments of the invention. As shown in FIG. 10, the light source 20 produces ray of light 102, ray of light 104, ray of light 106 and ray of light 108. The ray 102 and ray 104 are reflected by the envelope 10 to effectively produce an image of the light source 20 within the envelope 10 as shown schematically as L1 in FIG. 10. As also shown in FIG. 10, the ray 106 and ray 108 are reflected by the envelope 10 to effectively produce an image of the light source 20 within the envelope 10 as shown schematically as L2 in FIG. 10.

As shown in FIG. 10, the portion of the ray of light 102 and portion of the ray of light 104 that pass through the envelope 10 are refracted by the envelope 10 to produce refracted ray of light 110 and refracted ray of light 112 that produce wave fronts 118. The portion of the ray of light 106 and portion of the ray of light 108 that pass through the envelope 10 are refracted by the envelope 10 to produce refracted ray of light 114 and refracted ray of light 116 that produce wave fronts 120.

As shown in FIG. 10, the wave fronts 118 and wave fronts 120 produce interference pattern 122. In conventional systems, interference is normally not visible because the light emitting plans are too big and interference would be visible in such conventional systems with narrow light bunches or a point source of light.

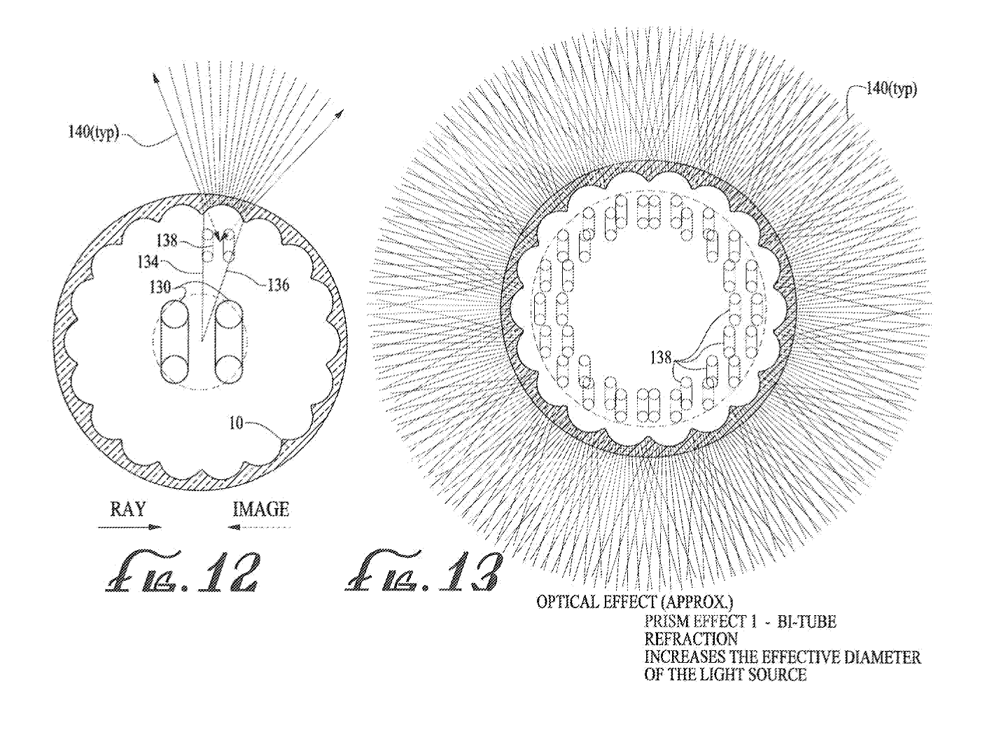

FIG. 11 illustrates an embodiment of the invention with a bi-tube light source 130 that is to be placed within the envelope 10. In these embodiments, the light source 130 is a xenon gas capacitor discharge flash bi-tube but the present invention includes and encompasses other photographic light sources known to persons skilled in the art.

In further embodiments, the light source 130 is configured to include threaded connectors 132 configured to couple to compatible threading (not shown) on the base of the envelope 10. The light source 130 is coupled to the envelope 10 in one or more embodiments by rotating or threading the light source 130 by hand into the envelope 10 in a manner known to skilled persons.

FIG. 12 illustrates the bi-tube light source 130 that produces the ray of light 134 and the ray of light 136 within the envelope 10. The ray 134 and ray 136 are reflected by the envelope 10 to effectively produce an image 138 of the bi-tube light source 130 within the envelope 10. Portions of the rays of light 134 and 136 are refracted by the envelope 10 as illustrated in FIG. 12 to produce refracted light rays 140 outside of the envelope 10.

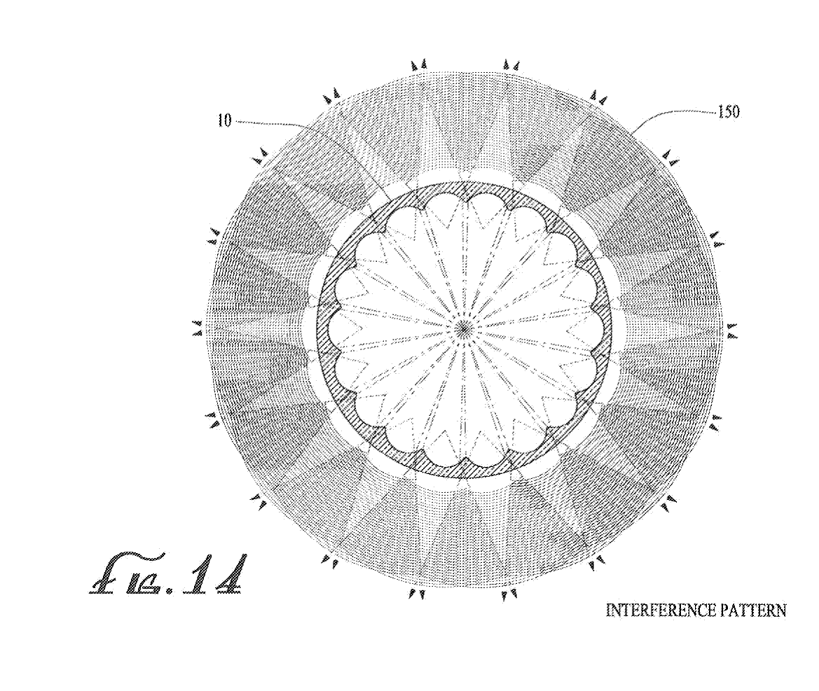

FIG. 13 illustrates an expanded view of the embodiment of the invention in FIG. 12 illustrating multiple images 138 and multiple refracted light rays 140. As can be appreciated from the Figures and the description herein, the configuration of the envelope 10 can be viewed as increasing the effective diameter of the light source 130. FIG. 14 is a diagram illustrative of the approximate interference pattern 150 of the light that can be produced by embodiments of the invention for stage, studio, motion picture and still photography.

While the present invention has been described with regards to particular embodiments, it is recognized that additional variations of the present invention may be devised without departing from the inventive concepts described herein and the invention is entitled to the full breadth and scope of the claims including all equivalents.

What is claimed is:

1. An envelope for a photographic light source, the envelope comprising a plurality of linear lenses and configured to substantially surround a photographic light source.

2. The envelope of claim 1 wherein the envelope comprises a borosilicate glass.

3. The envelope of claim 1 wherein the envelope has a substantially cylindrical configuration.

4. A method for producing light comprising the steps of configuring a photographic light source within a glass envelope, the envelope comprising a plurality of linear lenses, assembling the combined photographic light source and envelope to a reflector, and causing the light source to produce light.
